(19) United States
(12) Patent Application Publication
(10) Pub. No.: US 2021/0318201 A1
(43) Pub. Date: Oct. 14, 2021

(54) Pressure Vessel Leak Detection System

(71) Applicant: Booz Allen Hamilton Inc., McLean, VA (US)

(72) Inventors: Paige Elizabeth DANIEL, Mount Hope, AL (US); Jacques Phillip DAVIGNON, II, Atlanta, GA (US); Nicholas Graham FARROW, Huntsville, AL (US); Catherine Anne HENDERSON, Madison, AL (US); Jackson Lee HILL, Athens, AL (US); Michael Andrew STROBEL, Gulf Shores, AL (US); Dusty VARCAK, Harvest, AL (US)

(73) Assignee: Booz Allen Hamilton Inc., McLean, VA (US)

(21) Appl. No.: 16/843,278

(22) Filed: Apr. 8, 2020

(51) Int. Cl. G01M 3/32; F17D 5/02

(52) U.S. Cl. CPC G01M 3/3263; F17D 5/02

(57) ABSTRACT

Disclosed is a fluid leak detection system for monitoring leaks in a pressurized vessel. The system includes a temperature sensor, a pressure sensor, and a processing module. The processing module is configured to any one or combination of: compare a temperature output from the temperature sensor to a reference temperature to produce a temperature differential; or compare a pressure output from the pressure sensor to a reference pressure to produce a pressure differential. The processing module is configured to any one or combination of: monitor the pressure differential to indicate when a leak occurs in a pressurized vessel; or monitor the temperature differential to indicate when a leak occurs in a pressurized vessel. The processing module is configured to generate an alert when a leak is detected.

### FIELD

Embodiments relate to a fluid leak detection system for monitoring leaks in a pressurized vessel that takes into account pressure and temperature of the fluid within the pressurized vessel.

### BACKGROUND INFORMATION

Known fluid leak detection systems rely on measuring a change in pressure within the pressurized system without regard to other factors that may affect a change in pressure, thereby leading to inaccurate or false readings.

### SUMMARY

An exemplary embodiment is directed towards a fluid leak detection system for monitoring leaks in a pressurized vessel. The system includes a temperature sensor, a pressure sensor, and a processing module. The processing module is configured to any one or combination of: compare a temperature output from the temperature sensor to a reference temperature to produce a temperature differential; or compare a pressure output from the pressure sensor to a reference pressure to produce a pressure differential. The processing module is configured to any one or combination of: monitor the pressure differential to indicate when a leak occurs in a pressurized vessel; or monitor the temperature differential to indicate when a leak occurs in a pressurized vessel. The processing module is configured to generate an alert when a leak is detected.

Another exemplary embodiment is directed towards a fluid leak detection system for monitoring leaks in a pressurized vessel. The system includes a pressurized vessel configured to contain a substance under pressure. The system includes a housing configured to house or support a temperature sensor, a pressure sensor, and a processing module, wherein the housing has a distal end and a proximal end, the distal end includes a connector coupling configured to connect the housing to a port that provides access to the pressurized vessel. The processing module is configured to any one or combination of: compare a temperature output from the temperature sensor to a reference temperature to produce a temperature differential; or compare a pressure output from the pressure sensor to a reference pressure to produce a pressure differential. The processing module is configured to any one or combination of: monitor the pressure differential to indicate when a leak occurs in the pressurized vessel; or monitor the temperature differential to indicate when a leak occurs in the pressurized vessel. The processing module is configured to generate an alert when a leak is detected.

Another exemplary embodiment is directed to a method for detecting a fluid leak in a pressurized vessel. The method involves obtaining a temperature reading and obtaining a pressure reading. The method involves any one or combination of: comparing a temperature output from the temperature sensor to a reference temperature to produce a temperature differential; or comparing a pressure output from the pressure sensor to a reference pressure to produce a pressure differential. The method involves any one or combination of: monitoring the pressure differential to indicate when a leak occurs in a pressurized vessel; or monitoring the temperature differential to indicate when a leak occurs in a pressurized vessel. The method involves generating an alert when the leak is detected.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system architecture of an embodiment of the fluid leak detection system;

FIG. 2 shows an exemplary embodiment of the fluid leak detection system configured as an apparatus that can be coupled to a helicopter rotor spar; and

FIG. 3 shows an exemplary embodiment of the fluid leak detection system coupled to a helicopter rotor spar.

### DETAILED DESCRIPTION

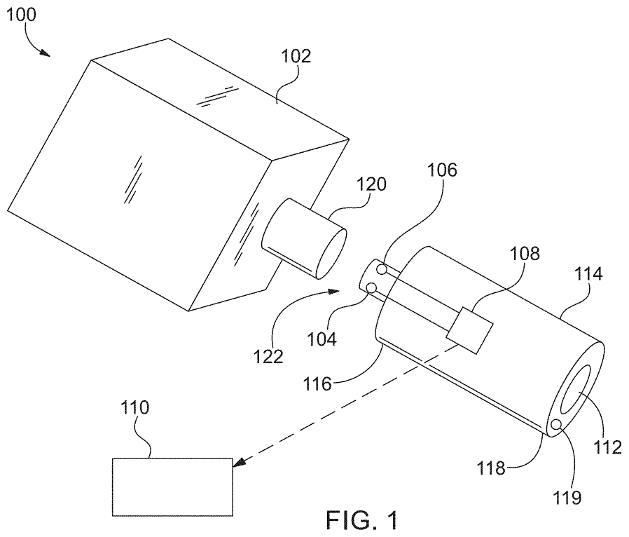

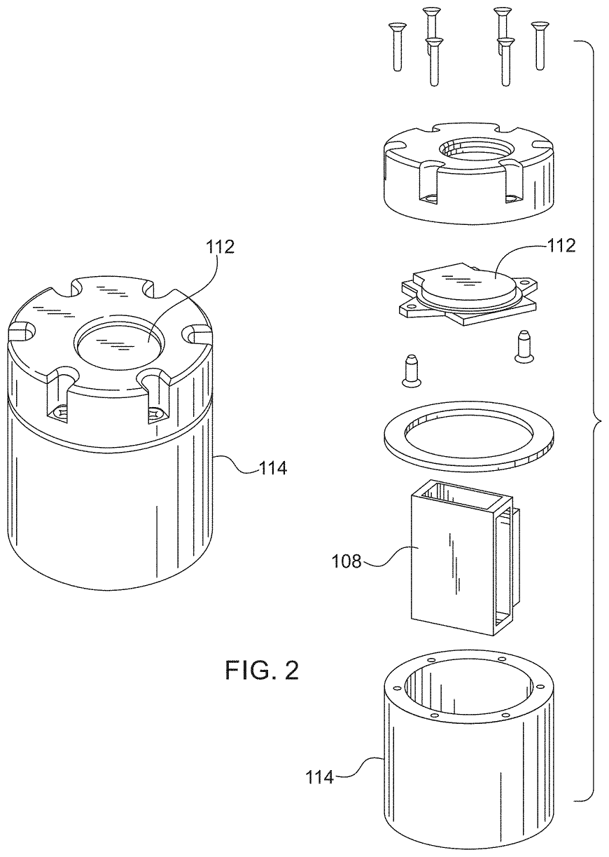

Referring to FIGS. 1-2, embodiments relate to a fluid leak detection system 100 for monitoring leaks in a pressurized vessel 102. The system 100 includes a temperature sensor 104 configured to measure a temperature of fluid within the pressurized vessel 102 and generate temperature data in the form of a temperature output. The system 100 includes a pressure sensor 106 configured to measure a pressure of the fluid within the pressurized vessel 102 and generate pressure data in the form of a pressure output. The system 100 includes a processing module 108 configured to receive the temperature output from the temperature sensor 104 and compare the temperature output to a reference temperature to produce a temperature differential. In addition, or in the alternative, a processing module 108 is configured to receive the pressure output from the pressure sensor 106 and compare the pressure output to a reference pressure to produce a pressure differential. The processing module 108 monitors the pressure differential to indicate when a leak occurs in a pressurized vessel 102. In addition, or in the alternative, the processing module 108 monitors the temperature differential to indicate when a leak occurs in a pressurized vessel 102. The processing module 108 can then generate an alert when a leak is detected. The alert can be an electronic signal, an optical signal, some other electromagnetic signal, etc.

Embodiments of the system 100 are able to take into account pressure and temperature of the fluid within the pressurized vessel 102 so as to reduce or eliminate false alarms. For instance, known fluid leak detection systems merely measure pressure and generate an alert when the measured pressure false below a threshold value. This has the propensity to generate a false alarm, especially when the pressurized vessel (or the fluid within the pressurized vessel) is subjected to changes in temperature. A well-known example of this is when the pressure sensor of a vehicle's tire generates an alert when the ambient air temperature deceases due to a change in weather. There may or may not be a leak in such situations, but a more accurate reading and a way to obviate a false alert is to factor in the temperature of the air within the tire. For example, using the Ideal Gas Law, one can account for what the pressure should be (e.g., the reference pressure) at a given temperature (e.g., the measured temperature) and then adjust the pressure threshold based on that before generating an alert. Thus, the measured pressure can then be compared to the reference pressure based on the measured temperature.

The processing module 108 can include at least one processor in operative association with a memory. The memory can include any one or combination of a volatile memory or a non-volatile memory. Any of the processors disclosed herein can be hardware (e.g., processor, integrated circuit, central processing unit, microprocessor, core processor, computer device, etc.), firmware, software, etc. configured to perform operations by execution of instructions embodied in algorithms, data processing program logic, automated reasoning program logic, etc. Any of the processors can include switches, transmitters, transceivers, routers, gateways, wave-guides, etc. to facilitate communications via a communication protocol that facilitates controlled and coordinated signal transmission and processing to and from various components of the system 100. The transmission can be via a communication link. The communication link can be electronic-based, optical-based, opto-electronic-based, quantum-based, etc. The communication link can be via hardwire or wireless.

In addition, any of the components can have an application programming interface (API) and/or other interfaces configured to facilitate a computer device 110 in communication with the system 100 executing commands and controlling aspects of any one or combination of components of the system 100. For example, an embodiment of the system 100 can include a computer device 110 (e.g., a server, a mainframe computer, a desk top computer, a laptop computer, a tablet, a smartphone, etc.) configured to be in communication with any one or combination of components of the system 100. The computer device 100 can also have a processor in operative association with a memory. The memory can include any one or combination of a volatile memory or a non-volatile memory. The processor of the computer device 110 can be in communication with the processor of the processing module 108. The computer device 110 can be programmed to generate a user interface configured to facilitate control of and display of various operational aspects of the system 100, including operational aspects of any component of the system 100. For instance, the computer device 110 may be used to adjust the temperature and/or pressure thresholds at with the processing module 108 generates am alert, adjust the formula by which the reference temperature and/or the reference pressure is calculated, adjust how the processing module 108 makes comparisons of the measured temperature/pressure with the reference temperature/pressure, control which temperature sensors 104 (if more than on is used) and/or pressure sensors 106 (if more than one is used) to employ when the system 100 is in use, etc.

In some embodiments, the monitoring performed by the processing module 108 involves any one or combination of: observing the pressure differential to make an assessment of whether a leak occurred; or observing the temperature differential to make an assessment of whether a leak occurred. For instance, the processing module 108 can receive the pressure output from the pressure sensor 106 and compare the pressure output to a reference pressure. As will be explained below, the reference pressure can be determined by the Ideal Gas Law, for example. The processing module 108 can be configured to monitor the pressure differential (any difference between the measured pressure and the reference pressure, a certain amount of difference between the measured pressure and the reference pressure, etc.) to determine if a leak is/has occurring/occurred in the pressurized vessel 102. For example: a) if the reference pressure is P₁ and the measured pressure is any P that differs from P₁, this can be an indicator of a leak; b) if the reference pressure is P₁ and the measured pressure is P₁±_{Δ}P (_{Δ}P being any unit of pressure measurement), this can be an indicator of a leak.

The processing module 108 can receive the temperature output from the temperature sensor 104 and compare the temperature output to a reference temperature. As will be explained below, the reference temperature can be determined by the Ideal Gas Law, for example. The processing module 108 can be configured to monitor the temperature differential (any difference between the measured temperature and the reference temperature, a certain amount of difference between the measured temperature and the reference temperature, etc.) to determine if a leak is/has occurring/occurred in the pressurized vessel 102. For example: a) if the reference temperature is T₁ and the measured temperature is any T that differs from T₁, this can be an indicator of a leak; b) if the reference temperature is T₁ and the measured temperature is T₁±_{Δ}T (_{Δ}T being any unit of temperature measurement), this can be an indicator of a leak.

In some embodiments, the monitoring performed by the processing module 108 involves combining the pressure differential and the temperature differential to make an assessment of whether a leak occurred. For instance, the processing module 108 can receive the pressure output from the pressure sensor 106 and receive the temperature output from the temperature sensor 104. The processing module 108 can then compare the pressure output to a reference pressure (the reference pressure being a function of the temperature output) and/or compare the temperature output to a reference temperature (the reference temperature being a function of the pressure output). Again, the reference pressure and/or reference temperature can be determined by the Ideal Gas Law, for example.

For instance, the reference temperature for fluid within the pressurized vessel 102 may be determined by PV=nRT, wherein:

P=the measured pressure (or pressure output from the pressure sensor 106);

V=a volume of the fluid confined to the pressurized vessel 102;

n=number of moles of the fluid confined to the pressurized vessel 102;

R=Boltzmann constant for the fluid; and

T=the reference temperature for the fluid obtained by solving PV=nRT.

The reference pressure for fluid within the pressurized vessel 102 can be determined by PV=nRT, wherein:

T=the measured temperature (or temperature output from the temperature sensor 104);

V=a volume of the fluid confined to the pressurized vessel 102;

n=number of moles of the fluid confined to the pressurized vessel 102;

R=Boltzmann constant for the fluid; and

P=the reference pressure for the fluid obtained by solving PV=nRT.

R is well documented for various fluids, and in particular gases. Thus, a user can easily obtain values for R based on the type of fluid in the pressurized vessel 102. n can be easily determined by dividing the mass of the fluid by the mass of one mole of the fluid.

While the Ideal Gas Law can be used, other mathematical formulas modeling thermodynamic pressure and temperature dependencies of a fluid can be used. For instance, the reference temperature for the fluid within the pressurized vessel 102 can be determined by

$$[ P + {a ( \frac{n}{V} )}^{2} ] ( \frac{V}{n} - b ) = RT ,$$

wherein:

P=the measured pressure (or pressure output from the pressure sensor 106);

V=a volume of the fluid confined to the pressurized vessel 102;

n=number of moles of the fluid confined to the pressurized vessel 102;

R=Boltzmann constant for the fluid;

a=a first van der Waals constant for the fluid;

b=a second van der Waals constant for the fluid; and

T=the reference temperature obtained for the fluid by solving

$$[ P + {a ( \frac{n}{V} )}^{2} ] ( \frac{V}{n} - b ) = RT .$$

The reference pressure for the fluid within the pressurized vessel 102 can be determined by

$$[ P + {a ( \frac{n}{V} )}^{2} ] ( \frac{V}{n} - b ) = RT ,$$

wherein:

T=the measured temperature (or temperature output from the temperature sensor 104);

V=a volume of the fluid confined to the pressurized vessel 102;

n=number of moles of the fluid confined to the pressurized vessel 102;

R=Boltzmann constant for the fluid;

a=a first van der Waals constant for the fluid;

b=a second van der Waals constant for the fluid; and

P=the reference pressure obtained for the fluid by solving

$$[ P + {a ( \frac{n}{V} )}^{2} ] ( \frac{V}{n} - b ) = RT .$$

R, a, and b are well documented for various fluids, and in particular gases. Thus, a user can easily obtain values for R, a, and b based on the type of fluid in the pressurized vessel 102. Again, n can be easily determined by dividing the mass of the fluid by the mass of one mole of the fluid.

The fluid can includes at least one gas. Some embodiments can be used with the fluid comprising more than one gas. For instance, the fluid can be nitrogen, oxygen, hydrogen, carbon dioxide, carbon monoxide, methane, butane, air (nitrogen, oxygen, argon, carbon dioxide), coke gas (hydrogen, methane, carbon monoxide, nitrogen), etc.

Some embodiments of the system 100 can include a display 112. The display 112 can be a liquid crystal display, a plasma display, a light emitting diode display, etc. that can receive the alert and generate a visual warning signal. For instance, the display 112 can be in electrical communication with the processing module 108 and be equipped with the necessary signal processing and filtering hardware to generate a visual warning signal representative of the alert. The alert can be generated when the pressure output is detected to be below or above a predetermined threshold, when the pressure output does not equal the reference pressure, when the pressure output is above or below the reference pressure by a predetermined amount, etc. In addition, or in the alternative, the alert can be generated when the temperature output is detected to be below or above a predetermined threshold, when the temperature output does not equal the reference temperature, when the temperature output is above or below the reference temperature by a predetermined amount, etc. In an exemplary embodiment, the alert is be generated when the pressure output does not equal the reference pressure (the reference temperature being determined by the temperature output), or when the pressure output is above or below the reference pressure (the reference temperature being determined by the temperature output) by a predetermined amount. The visual warning signal representative of the alert can be indicative of any one or combination of these conditions. The visual warning signal can be textual, graphical, an interactive graphic, etc. In some embodiments, the visual warning signal is accompanied with an audible signal. For instance, the system 100 can include a speaker 119 in electrical communication with the processing module 108 and equipped with the necessary signal processing and filtering hardware to generate sound that is representative of the alert when the speaker 119 receives the alert signal from the processing module 108.

In some embodiments, the display 112 also includes a processor in operative association with a memory. The memory can include any one or combination of a volatile memory or a non-volatile memory. The display 112 can be configured to generate a user interface in addition to the visual warning signal representative of the alert. The user interface can be configured to facilitate control of and display of various operational aspects of the system 100, including operational aspects of any component of the system 100.

In some embodiments, the system 100 includes a housing 114 configured to house or support the temperature sensor 104, the pressure sensor 106, and the processing module 108. It should be noted that while exemplary embodiments show the processing module 108 being housed within the housing 114, it need not be. The housing 114 has a distal end 116 and a proximal end 118. The distal end 116 includes a connector coupling 122 (e.g., interference fit, bayonet coupling, quick-connect coupling, threaded engagement, etc.) configured to connect the housing 114 to a port 120, the port 120 providing access to the pressurized vessel 102. The proximal end 118 includes the display 112 and/or the speaker 119. The temperature sensor 104 and the pressure sensor 106 are located at or near the distal end 116. The temperature sensor 104 includes one or more of a negative temperature coefficient thermistor, a resistance temperature detector, a thermocouple, a semiconductor-based sensor, an infrared temperature reader, etc. The pressure sensor 106 includes one or more of an absolute pressure sensor, a gauge pressure sensor, a differential pressure sensor, etc. When coupled to the pressurized vessel 102, a hermetic seal is formed between the connector coupling 122 and the port 120. This can be achieved via the use of gaskets, diaphragms, valves, etc. Once the device is coupled to the pressurized vessel 102 via the connector coupling 122, the temperature sensor 104 and the pressure sensor 106 (being within the confines of the hematic seal) are exposed to the fluid, and are therefore able to obtain readings of the pressure of the fluid and/or temperature of the fluid.

In some embodiments, the system 100 can include a communication system including a communications interface configured to facilitate wired or wireless transmission of data. As noted above, the system 100 can include a computer device 110 configured to send and receive information to and from the processing module 108. This can include receiving alert signals from the processing module 108, receiving visual warning signals from the display 112, sending command and control signals to the processing module 108, the display 112, the speaker 119, or other components of the system 100. The computer device 110 can be in wired or wireless communication with the processing module 108, the display 112, the speaker 119, or other components of the system 100.

In an exemplary embodiment, the fluid leak detection system 100 for monitoring leaks in a pressurized vessel 102 includes a pressurized vessel 102 configured to contain a substance under pressure. The system 100 includes a housing 114 configured to house or support a temperature sensor 104, a pressure sensor 106, and a processing module 108, wherein the housing 114 has a distal end 116 and a proximal end 118. The distal end 116 includes a connector coupling 122 configured to connect the housing 114 to a port 120 that provides access to the pressurized vessel 102. The processing module 108 is configured to any one or combination of: compare a temperature output from the temperature sensor 104 to a reference temperature to produce a temperature differential; or compare a pressure output from the pressure sensor 106 to a reference pressure to produce a pressure differential. The processing module 108 is configured to any one or combination of: monitor the pressure differential to indicate when a leak occurs in the pressurized vessel 102; or monitor the temperature differential to indicate when a leak occurs in the pressurized vessel 102. The processing module 108 is configured to generate an alert when a leak is detected.

In some embodiments, the substance includes a fluid.

In some embodiments, the substance includes a fluid and an object.

In some embodiments, the pressurized vessel 102 is a hermetically sealed container.

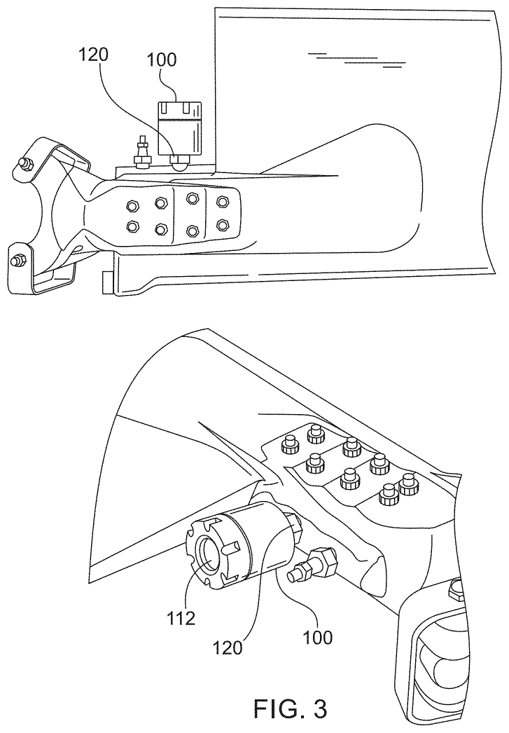

In some embodiments, the pressurized vessel 102 is any one of a tire, an interior spar portion of a helicopter rotor blade (see FIG. 3), a container configured to transport objects sensitive to changes in pressure, etc. Thus, the object can be an organ or other object that is required to be within a pressurized vessel 102 (e.g., transportation of an organ for organ transplant surgery).

In an exemplary embodiment, a method for detecting a fluid leak in a pressurized vessel 102 involves obtaining a temperature reading. The method involves obtaining a pressure reading. The method involves any one or combination of: comparing a temperature output from the temperature sensor 104 to a reference temperature to produce a temperature differential; or comparing a pressure output from the pressure sensor 106 to a reference pressure to produce a pressure differential. The method involves any one or combination of: monitoring the pressure differential to indicate when a leak occurs in a pressurized vessel; or monitoring the temperature differential to indicate when a leak occurs in a pressurized vessel. The method involves generating an alert when the leak is detected.

It will be understood that modifications to the embodiments disclosed herein can be made to meet a particular set of design criteria. For instance, any of the pressure sensors 106, temperature sensors 104, processing modules 108, displays 112, computer devices 110, or any other component of the system 100 can be any suitable number or type of each to meet a particular objective. Therefore, while certain exemplary embodiments of the system 100 and methods of making and using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein. Additionally, the disclosure of a range of values is a disclosure of every numerical value within that range, including the end points.

What is claimed is:

1. A fluid leak detection system for monitoring leaks in a pressurized vessel, the system comprising:
a temperature sensor;
a pressure sensor; and
a processing module configured to:
any one or combination of:
compare a temperature output from the temperature sensor to a reference temperature to produce a temperature differential; or
compare a pressure output from the pressure sensor to a reference pressure to produce a pressure differential; and
any one or combination of:
monitor the pressure differential to indicate when a leak occurs in a pressurized vessel; or
monitor the temperature differential to indicate when a leak occurs in a pressurized vessel; and
generate an alert when a leak is detected.

2. The system of claim 1, wherein the monitoring includes any one or combination of:
observing the pressure differential to make an assessment of whether a leak occurred; or
observing the temperature differential to make an assessment of whether a leak occurred.

3. The system of claim 1, wherein the monitoring includes combining the pressure differential and the temperature differential to make an assessment of whether a leak occurred.

4. The system of claim 1, wherein the reference temperature for fluid within the pressurized vessel is determined by PV=nRT, wherein:
P=the measured pressure;
V=a volume of the fluid confined to the pressurized vessel;
n=number of moles of the fluid confined to the pressurized vessel;
R=Boltzmann constant for the fluid; and
T=the reference temperature for the fluid obtained by solving PV=nRT.

5. The system of claim 1, wherein the reference pressure for fluid within the pressurized vessel is determined by PV=nRT, wherein:
T=the measured temperature;
V=a volume of the fluid confined to the pressurized vessel;
n=number of moles of the fluid confined to the pressurized vessel;
R=Boltzmann constant for the fluid; and
P=the reference pressure for the fluid obtained by solving PV=nRT.

6. The system of claim 1, wherein the reference temperature for the fluid within the pressurized vessel is determined by
$$[ P + {a ( \frac{n}{V} )}^{2} ] ( \frac{V}{n} - b ) = RT ,$$
wherein:
P=the measured pressure;
V=a volume of the fluid confined to the pressurized vessel;
n=number of moles of the fluid confined to the pressurized vessel;
R=Boltzmann constant for the fluid;
a=a first van der Waals constant for the fluid;
b=a second van der Waals constant for the fluid; and
T=the reference temperature obtained for the fluid by solving
$$[ P + {a ( \frac{n}{V} )}^{2} ] ( \frac{V}{n} - b ) = RT .$$

7. The system of claim 1, wherein the reference pressure for the fluid within the pressurized vessel is determined by
$$[ P + {a ( \frac{n}{V} )}^{2} ] ( \frac{V}{n} - b ) = RT ,$$
wherein:
T=the measured temperature;
V=a volume of the fluid confined to the pressurized vessel;
n=number of moles of the fluid confined to the pressurized vessel;
R=Boltzmann constant for the fluid;
a=a first van der Waals constant for the fluid;
b=a second van der Waals constant for the fluid; and
P=the reference pressure obtained for the fluid by solving
$$[ P + {a ( \frac{n}{V} )}^{2} ] ( \frac{V}{n} - b ) = RT .$$

8. The system of claim 1, wherein the fluid includes at least one gas.

9. The system of claim 1, wherein the fluid includes more than one gas.

10. The system of claim 1, wherein the fluid includes nitrogen gas.

11. The system of claim 1, comprising:
a display configured to receive the alert and generate a visual warning signal.

12. The system recited in claim 11, comprising:
a housing configured to house or support the temperature sensor, the pressure sensor, and the processing module, wherein the housing has a distal end and a proximal end;
the distal end includes a connector coupling configured to connect the housing to a port that provides access to the pressurized vessel; and
the proximal end includes the display.

13. The system recited in claim 1, wherein:
the temperature sensor includes one or more of a negative temperature coefficient thermistor, a resistance temperature detector, a thermocouple, or a semiconductor-based sensor; and
the pressure sensor includes one or more of an absolute pressure sensor, a gauge pressure sensor, or a differential pressure sensor.

14. The system recited in claim 1, comprising:
a communication system including a communications interface configured to facilitate wired or wireless transmission of data.

15. A fluid leak detection system for monitoring leaks in a pressurized vessel, the system comprising:
a pressurized vessel configured to contain a substance under pressure; and
a housing configured to house or support a temperature sensor, a pressure sensor, and a processing module, wherein the housing has a distal end and a proximal end, the distal end includes a connector coupling configured to connect the housing to a port that provides access to the pressurized vessel;
wherein the processing module is configured to:
any one or combination of:
compare a temperature output from the temperature sensor to a reference temperature to produce a temperature differential; or
compare a pressure output from the pressure sensor to a reference pressure to produce a pressure differential;
any one or combination of:
monitor the pressure differential to indicate when a leak occurs in the pressurized vessel; or
monitor the temperature differential to indicate when a leak occurs in the pressurized vessel; and
generate an alert when a leak is detected.

16. The system recited in claim 15, wherein the substance includes a fluid.

17. The system recited in claim 15, wherein the substance includes a fluid and an object.

18. The system recited in claim 15, wherein the pressurized vessel is a hermetically sealed container.

19. The system recited in claim 15, wherein the pressurized vessel is any one of a tire, an interior spar portion of a helicopter rotor blade, or a container configured to transport objects sensitive to changes in pressure.

20. Method for detecting a fluid leak in a pressurized vessel, the method comprising:
obtaining a temperature reading;
obtaining a pressure reading;
any one or combination of:
comparing a temperature output from the temperature sensor to a reference temperature to produce a temperature differential; or
comparing a pressure output from the pressure sensor to a reference pressure to produce a pressure differential;
any one or combination of:
monitoring the pressure differential to indicate when a leak occurs in a pressurized vessel; or
monitoring the temperature differential to indicate when a leak occurs in a pressurized vessel; and
generating an alert when the leak is detected.
